(19) United States
(12) Patent Application Publication
(10) Pub. No.: US 2019/0092168 A1
(43) Pub. Date: Mar. 28, 2019

(54) ADAPTIVE CRUISE CONTROL SYSTEM AND METHOD

(71) Applicant: Continental Automotive Systems, Inc., Auburn Hills, MI (US)

(72) Inventors: Joseph Burtch, Lake Orion, MI (US); James H Critchley, Lake Orion, MI (US); Dominik Froehlich, Ferndale, MI (US)

(73) Assignee: Continental Automotive Systems, Inc., Auburn Hills, MI (US)

(21) Appl. No.: 16/141,692

(22) Filed: Sep. 25, 2018

Related U.S. Application Data
(60) Provisional application No. 62/562,820, filed on Sep. 25, 2017.

(51) Int. Cl. B60K 31/00

(52) U.S. Cl. CPC B60K 31/0008; B60K 2031/0025; B60K 2031/0033; B60K 2310/262; B60Y 2300/146; B60Y 2300/162; B60K 2310/244; B60Y 2200/11

(57) ABSTRACT

An adaptive cruise control system and method for controlling a speed of a vehicle includes determine a distance between a controlled vehicle a target vehicle with a distance sensor. An input sensor senses an input from a driver of the controlled vehicle in relation to the desired distance between the controlled vehicle and the target vehicle. An adaptive cruise control module receives a data set of a plurality of data points regarding the operation of the controlled vehicle. An artificial neural network is configured to receive the data set in response to the input from the driver being sensed and calculate a change in the desired distance in response to a change in at least one of the data points. A requested distance between vehicles is then changed based on at least one of the input from the driver and the calculated change in the desired distance by the artificial neural network.

### CROSS REFERENCE TO RELATED APPLICATION

This application claims the benefit of provisional patent application No. 62/562,820, filed Sep. 25, 2017, which is hereby incorporated by reference.

### TECHNICAL FIELD

The technical field relates generally to adaptive cruise control systems for vehicles.

### BACKGROUND

Adaptive cruise control (“ACC”), also referred to as autonomous cruise control, is a system that adjusts the speed of a controlled vehicle in order to maintain a safe distance from a target vehicle ahead of the controlled vehicle. An ACC system may utilize radar, lidar, and/or cameras to sense the distance between the vehicles.

ACC systems also typically require an operator of the vehicle to set a desired time gap between vehicles and a target speed. However, the desired time gap of the driver may change based on a number of factors. This often forces the driver to have to manually change the desired time gap numerous times. A driver may grow weary and/or dissatisfied with this, and abandon using the ACC system altogether.

As such, it is desirable to present an ACC system that reduces the need for changes in the desired time gap by the driver. In addition, other desirable features and characteristics will become apparent from the subsequent summary and detailed description, and the appended claims, taken in conjunction with the accompanying drawings and this background.

### SUMMARY

In one exemplary embodiments, a method of controlling a speed of a vehicle includes sensing an actual distance between the controlled vehicle and a target vehicle in front of the controlled vehicle. The method also includes controlling the controlled vehicle to maintain the actual distance between the controlled vehicle and the target vehicle that is greater than or equal to the requested distance. The method further includes receiving a data set of a plurality of data points regarding the operation of the controlled vehicle. The method also includes sensing an input from a driver of the controlled vehicle in relation to the desired distance between the controlled vehicle and the target vehicle. The method further includes providing the data set to an artificial neural network in response to the input being sensed. The method also includes calculating a change in the desired distance with the artificial neural network in response to a change in at least one of the data points. The method further includes changing the requested distance based on at least one of the input from the driver and the calculated change in the desired distance by the artificial neural network.

According to one exemplary embodiment, an adaptive cruise control system for controlling a speed of a vehicle includes a distance sensor configured to determine a distance between a controlled vehicle a target vehicle. The system also includes an input sensor for sensing an input from a driver of the controlled vehicle in relation to the desired distance between the controlled vehicle and the target vehicle. The system further includes an adaptive cruise control module configured to receive a data set of a plurality of data points regarding the operation of the controlled vehicle. The adaptive cruise control module includes an artificial neural network. The artificial neural network is configured to receive the data set in response to the input from the driver being sensed and calculate a change in the desired distance in response to a change in at least one of the data points. The adaptive cruise control module is further configured to change the requested distance based on at least one of the input from the driver and the calculated change in the desired distance by the artificial neural network.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a view of an exemplary roadway with a controlled vehicle and a target vehicle driving in the same lane;

FIG. 2 is a block diagram of an adaptive cruise control system according to one exemplary embodiment;

FIG. 3 is a block diagram of a traditional adaptive cruise control approach according to one embodiment;

FIG. 4 is a block diagram of an autonomous cruise control using an artificial neural network according to one embodiment; and

FIG. 5 is a flowchart of a method of controlling a speed of a vehicle according to one exemplary embodiment.

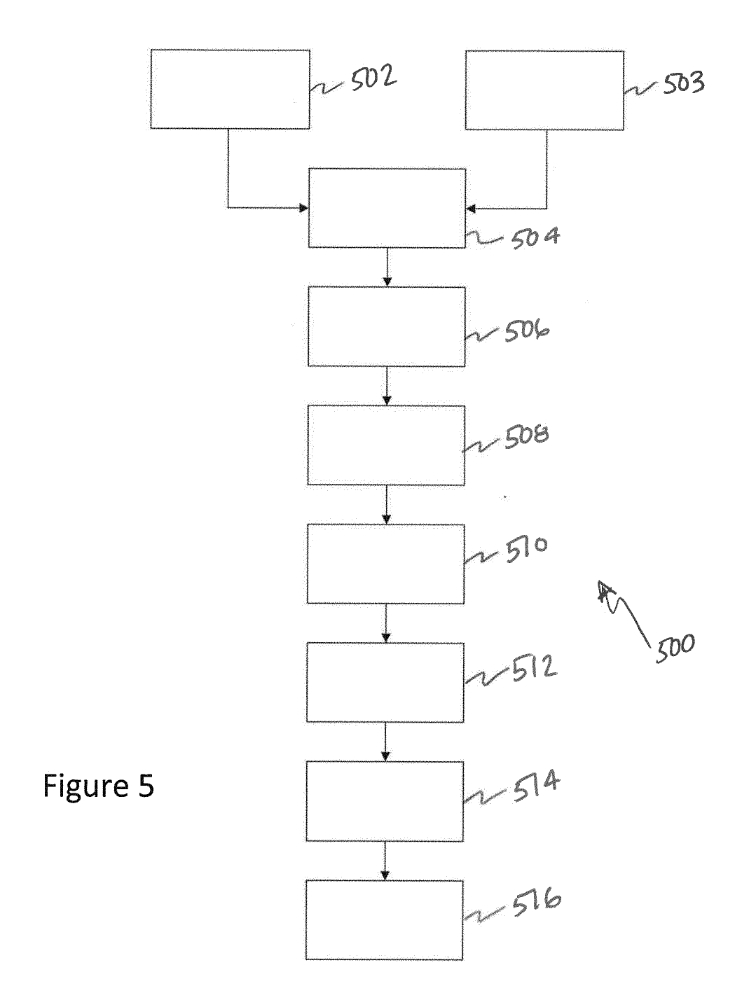

### DETAILED DESCRIPTION

Referring to the Figures, wherein like numerals indicate like parts throughout the several views, a system and method for controlling speed in a vehicle is shown and described herein.

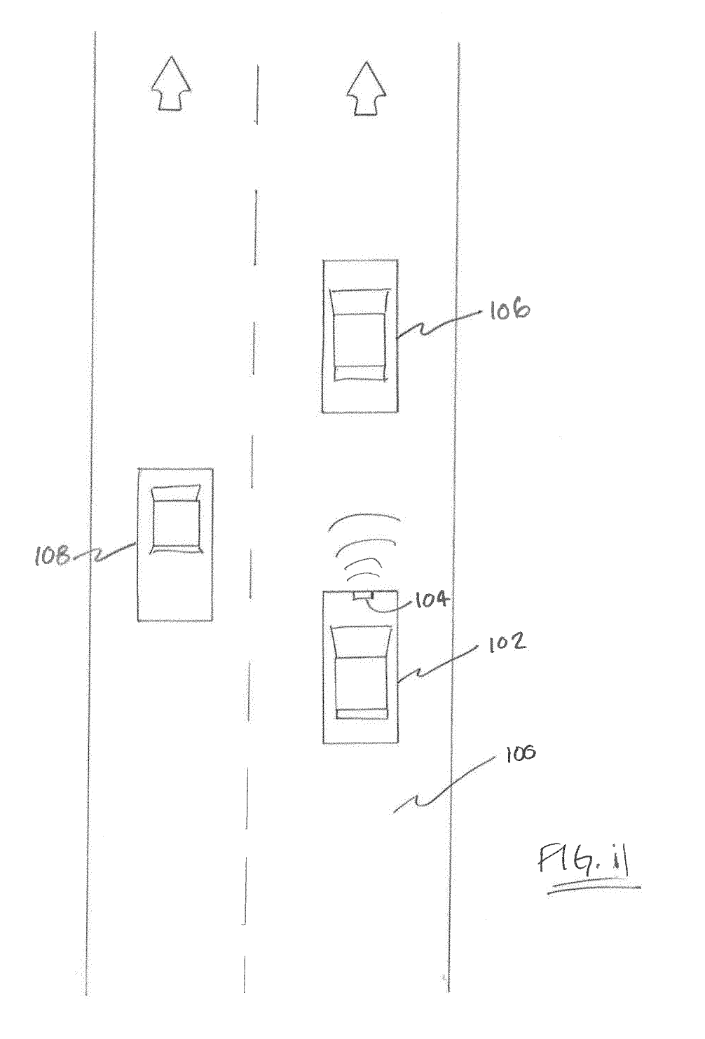

FIG. 1 shows a top view of an exemplary roadway 100 with two lanes (not numbered) of traffic proceeding in the same direction. A controlled vehicle 102 is equipped with an adaptive cruise control (“ACC”) system 104. A target vehicle 106 is moving in front of the controlled vehicle 102. A third vehicle 108, blocking the passing lane of the roadway 100, is also shown.

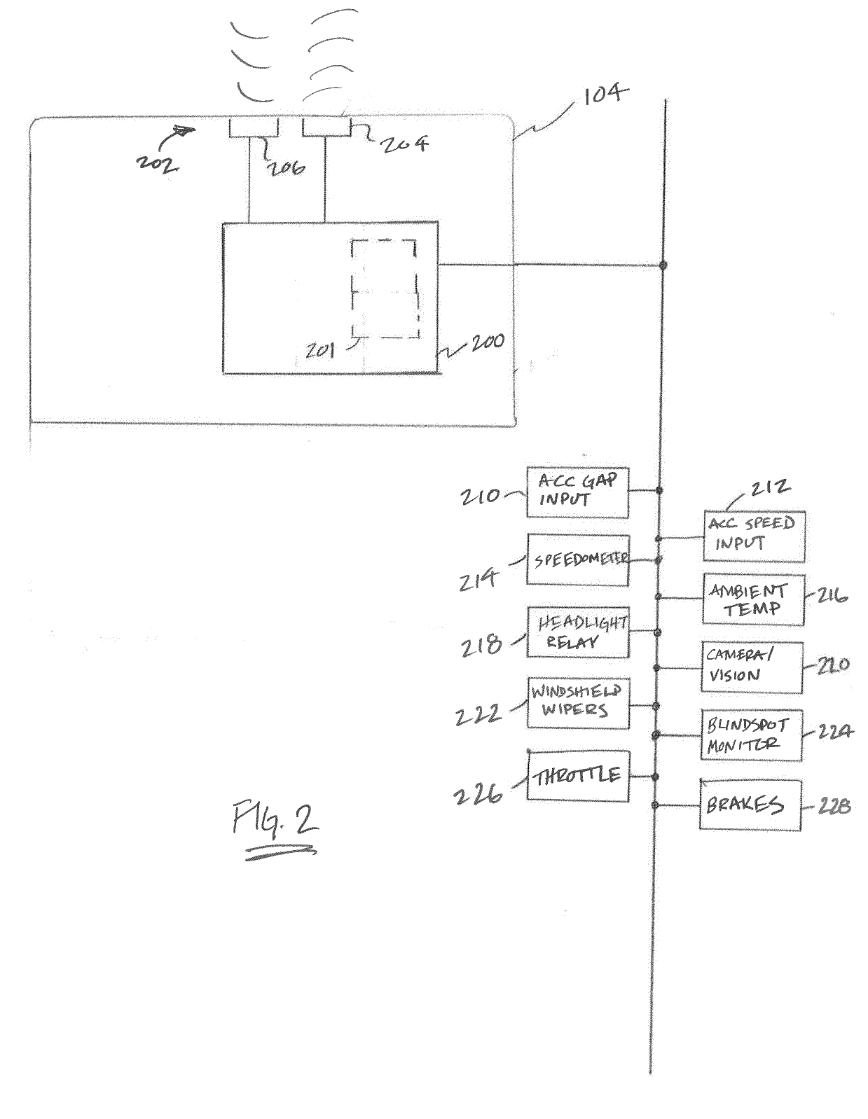

One exemplary embodiment of the ACC system 104 is shown in greater detail in FIG. 2. The ACC system 104 includes a processor 200. In the exemplary embodiment, the processor 200 is a semiconductor-based device capable of performing mathematical computations and/or executing a series of instructions (i.e., running a program). The processor 200 may be implemented with a microprocessor, microcontroller, application specific integrated circuit (“ASIC”), and/or any other suitable computational device.

In the exemplary embodiment, the processor 200 includes a memory 201. The memory 201 may be implemented with any suitable device for storing data, such as, but certainly not limited to, a random-access memory (“RAM”), a read-only memory (“ROM”), a flash memory, etc. In the embodiment shown in FIG. 2, the memory 201 is shown as being integrated with the processor 200. It should, however, be appreciated that the memory 201 may be separate from the processor 200 and thus, in communication with the processor 200. It should also be appreciated that more than one memory 201 may be implemented.

The processor 200 may also include other circuits and devices (not shown), such as, but not limited to, an analog-to-digital converter (“ADC”), a digital-to-analog converter (“DAC”), a clock circuit, communications processing circuits, etc., as necessary to support the functionality of the processor 200 and the ACC system 104 as described herein.

The ACC system 104 of the exemplary embodiment also includes a distance sensor 202. In this embodiment, the distance sensor 202 utilizes a radar transmitter 204 and radar receiver 206. The radar transmitter 204 directs a radio wave from the front of controlled vehicle 102. The radio wave is reflected off the target vehicle 106 and back to the radar receiver 206. The processor 200, in communication with the transmitter 204 and receiver 206, is then able to compute the distance to the target vehicle 106 using the time delay between transmission and reception of the radio wave, as is well known to those of ordinary skill in the art. The processor 200 is configured to receive a data set of a plurality of data points regarding the operation of the controlled vehicle 102, as described in greater detail below.

The ACC system 104 may be in communication with other components of the vehicle 102 via a communications bus 208. The communications bus 208 may be a CAN bus (not separately numbered) or another suitable communications medium as appreciated by those skilled in the art.

Other components of the vehicle 102 in communication with the processor 200 via the communications bus 208 may include, but are not limited to:
an ACC gap selection input 210;
an ACC speed selection input 212;
a vehicle speed sensor 214;
an ambient temperature sensor 216;
a headlight relay 218;
a camera and/or vision system 220;
a windshield wiper system 222;
a blindspot monitoring system 224;
a throttle 226; and
a braking system 228.

The ACC gap selection input 210 is configured to sense an input from a driver of the controlled vehicle 102 in relation to the desired distance between the controlled vehicle and the target vehicle 106. Said another way, the input sensor 210 allows the driver of the vehicle to select the size of a minimum gap between the controlled vehicle 102 and the target vehicle 106. In one exemplary embodiment, the input sensor 210 may be a toggle switch (not shown) that may be actuated by the driver to increase or decrease the desired size of the gap. However, other types of switches may also be used. Furthermore, the input sensor 210 may be implemented using a switch and/or sensor connected to the brake pedal of the vehicle 102.

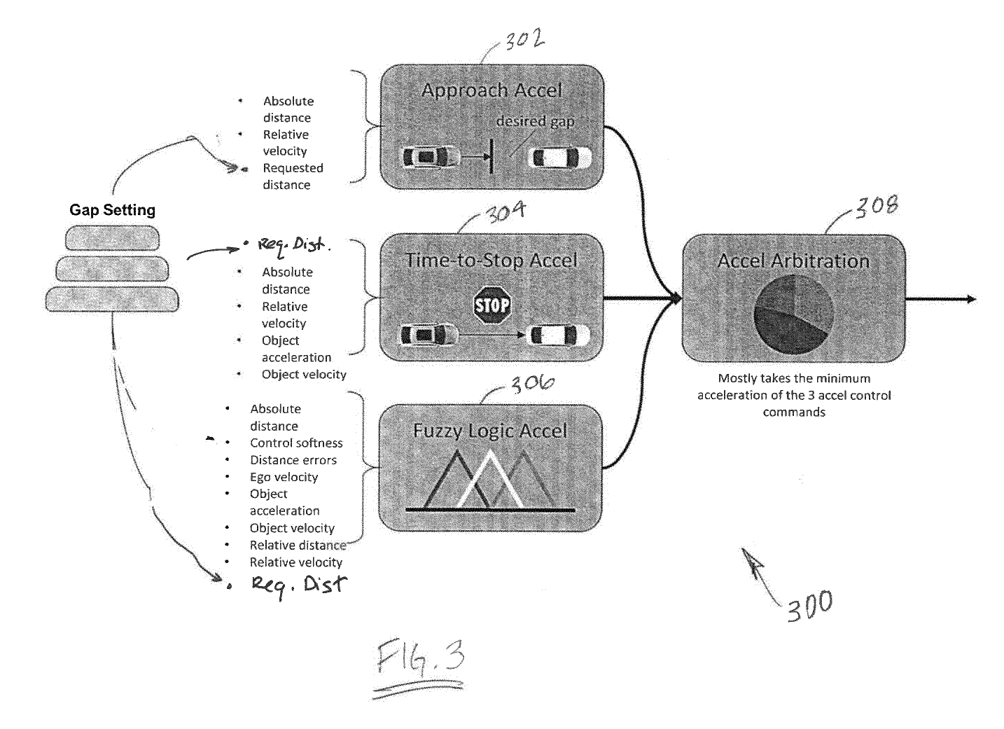

FIG. 3 shows a standard exemplary approach to autonomous cruise control showing a standard ACC algorithm 300. The ACC algorithm may be executed in the processor 200. In this approach, a gap setting is received from the driver. This gap setting is then used, along with other data, in calculating three acceleration control commands. The three acceleration control commands are determined by an approach acceleration algorithm 302, a time-to-stop acceleration algorithm 304, and a fuzzy logic acceleration algorithm 306. An acceleration arbitration algorithm 308 receives the outputs from the other algorithms 302, 304, 306 and determines an acceleration command that is used to control acceleration of the vehicle.

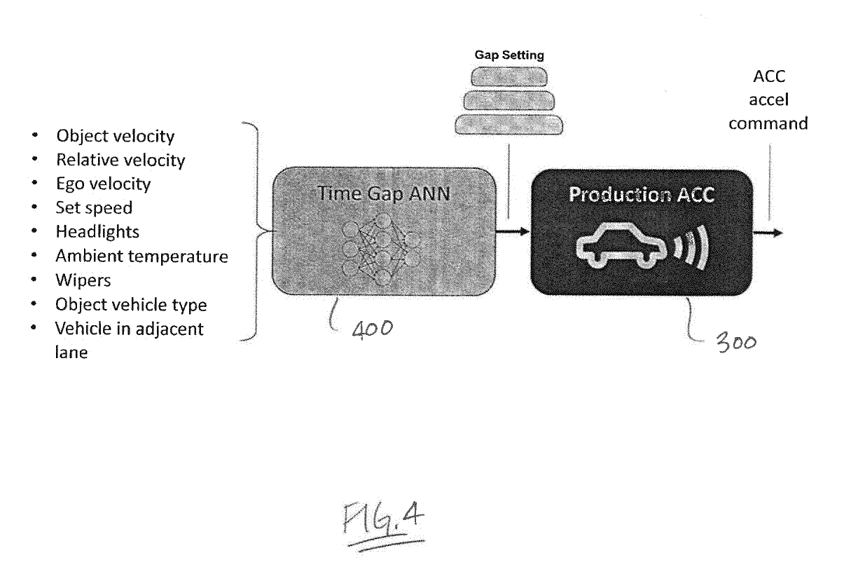

Referring now to FIG. 4, the ACC system 104 includes one or more artificial neural networks 400 (“ANNs”), for example, Deep Neural Networks. ANNs are computational approaches based on a large collection of neural unites, loosely imitating the way a biological brain solves problems with large clusters of biological neurons connected by axons. ANNs are self-learning and trained, rather than programmed, and excel in areas where the solution feature detection is difficult to express in a traditional computer program. In other words, ANNs are a set of algorithms that are designed to recognize patterns. ANNs interpret sensor system data (e.g., from various sensors) through a machine perception, labeling or clustering raw input.

The ANN 400 of the exemplary embodiment resides in the processor 200 including the memory 201. The ANN 400 may include multiple layers of nonlinear processing units (not shown) in communication with ANN non-transitory memory. The ANN non-transitory memory stores instructions that when executed on the nonlinear processing units cause the ANN to provide an output. Each nonlinear processing unit is configured to transform an input or signal (e.g., sensor data) using parameters that are learned through training. A series of transformations from inputs (e.g., sensor data) to outputs occurs at the multiple layers of the nonlinear processing units.

Operation of the ACC system 104 described above may be contemplated with discussion of a method 500 of controlling a speed of the vehicle 102, as described in detail below. However, it should be appreciated that the ACC system 104 may be implemented in embodiments other than those described in the method 500 below, and the method 500 may be implemented in apparatuses other than the above-described ACC system 104.

The method 500 may include, at 502, receiving a requested speed setpoint of the controlled vehicle 102. The driver may set this setpoint using a button and/or switch, as is readily appreciated by those skilled in the art. The requested speed setpoint may be stored in the memory 201, in one embodiment.

The method 500 further includes, at 503, determining a requested minimum distance, i.e., a gap distance, between the controlled vehicle 102 and the target vehicle 106. Determining the requested minimum distance may be initially set using the ACC gap selection input 210 as described above. However, the determination of the gap distance may be modified as described below.

If there is a target vehicle 106 in front of the controlled vehicle 102, the method 500 also includes, at 504, sensing an actual distance between the controlled vehicle 102 and the target vehicle 106. For example, the distance sensor 202 may utilized to compute a distance between the vehicles 102, 106, as described above and known to those skilled in the art.

The method 500 may further include, at 506, controlling the speed of the controlled vehicle 102 at the requested speed setpoint, while maintaining the minimum gap distance between the vehicles 102, 106. The processor 200, receiving vehicle speed from the speed sensor 214, may utilize various control algorithms and issue commands to the vehicle throttle 226 to control the speed of the vehicle 102, as is well known to those skilled in the art. The priority is to maintain the actual distance between the controlled vehicle and the target vehicle that as greater than or equal to the requested distance. When that actual distance is greater than or equal to the requested distance, then the throttle 226 of the controlled vehicle 102 is secondarily controlled to maintain the speed setpoint.

The method 500 also includes, at 508, receiving a data set of a plurality of data points regarding the operation of the controlled vehicle 102. These data points may include, but are not limited to:
a velocity of the target vehicle;
a velocity of the controlled vehicle;
a difference between the velocity of the target vehicle and the velocity of the controlled vehicle;
a requested speed setpoint of the controlled vehicle;
a status of the headlights of the controlled vehicle;
a status of the windshield wipers of the controlled vehicle;
an ambient temperature outside the controlled vehicle;
a type of the target vehicle; and
detection of another vehicle is adjacent to the controlled vehicle.

In one embodiment, the velocity of the controlled vehicle may be ascertained from the speed sensor 214. In one embodiment, the velocity of the target vehicle may be calculated by the distance sensor 202 and the processor 200. In one embodiment, the difference between the velocity of the target vehicle and the velocity of the controlled vehicle may be determined by the processor 200. In on embodiment, the requested speed setpoint of the controlled vehicle may be received from the ACC speed input 212 and stored in the memory 201. In one embodiment, the status of the headlights may be determined from the headlight relay 218. In one embodiment, the status of the windshield wipers may be received from the windshield wipers 222.

The method 500 also includes, at 510, sensing an input from a driver of the controlled vehicle 102 in relation to the desired distance between the controlled vehicle 102 and the target vehicle 106. For instance, when operating the vehicle with the ACC system 104, the driver of the controlled vehicle 102 may not be comfortable with the current gap between the vehicles 102, 106. In one situation, the driver may feel the gap is too small, yet in another situation, the driver may feel the gap is too large.

The driver's sense of an appropriate gap may change as driving conditions change. For example, at low speeds, the driver may tolerate a smaller gap than at high speeds. Weather conditions (rain, ice, etc.) may also play a role in the driver's preference for gap size—for instance, a bigger gap may be preferred when braking and visibility are impaired. The type and/or size of the target vehicle 106, as well as the presence of surrounding vehicles, may also play a role in the driver's gap preference.

The method 500 further includes, at 512, providing the data set to an artificial neural network 400 in response to the input being sensed. Said another way, when the driver signals a desired change in gap using the ACC gap input 210, various data (e.g., weather conditions, vehicle 102, 106 velocities, etc.) is sent to the ANN 400.

The ANN 400 may then use this data, collected over numerous instances, to calculate a change in the desired distance. This may be referred to as training the ANN 400 with the data set. As such, the method 500 also includes, at 514, calculating a change in the desired distance with the ANN 400 in response to a change in at least one of the data points.

In one exemplary embodiment, the training the ANN may utilize a gradient descent feedforward-backpropagation technique. In one exemplary embodiment, the data points of the data set may be normalized between 0 and 1.

The method 500 further includes, at 516, changing the requested distance based on at least one of the input from the driver and the calculated change in the desired distance by the ANN 400.

The method 500 may also include receiving an input selecting a driver profile from a plurality of driver profiles. Each driver profile may include a unique artificial neural network associated with one driver. By utilizing multiple driver profiles with unique artificial neural networks, the method 500 and system 200 may allow different drivers of the vehicle to have customized gap distance settings.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A method of controlling a speed of a vehicle comprising:
sensing an actual distance between the controlled vehicle and a target vehicle in front of the controlled vehicle;
controlling the controlled vehicle to maintain the actual distance between the controlled vehicle and the target vehicle that is greater than or equal to the requested distance;
receiving a data set of a plurality of data points regarding the operation of the controlled vehicle;
sensing an input from a driver of the controlled vehicle in relation to the desired distance between the controlled vehicle and the target vehicle;
providing the data set to an artificial neural network in response to the input being sensed;
calculating a change in the desired distance with the artificial neural network in response to a change in at least one of the data points; and
changing the requested distance based on at least one of the input from the driver and the calculated change in the desired distance by the artificial neural network.

2. The method as set forth in claim 1 further comprising:
receiving a requested speed setpoint of the controlled vehicle; and
controlling the speed of the controlled vehicle at the requested speed setpoint unless doing so would maintain a requested distance between the controlled vehicle and the target vehicle utilizing.

3. The method as set forth in claim 1 wherein receiving a data set of a plurality of data points regarding the operation of the controlled vehicle includes receiving at least one of:
a velocity of the target vehicle;
a velocity of the controlled vehicle;
a difference between the velocity of the target vehicle and the velocity of the controlled vehicle;
a requested speed setpoint of the controlled vehicle;
a status of the headlights of the controlled vehicle;
a status of the windshield wipers of the controlled vehicle;
an ambient temperature outside the controlled vehicle;
a type of the target vehicle; and
detection of another vehicle is adjacent to the controlled vehicle.

4. The method as set forth in claim 1 further comprising receiving an input selecting a driver profile from a plurality of driver profiles, wherein each driver profile includes a unique artificial neural network associated with one driver.

5. The method as set forth in claim 1 wherein providing the data set to an artificial neural network is further defined as training the artificial neural network with the data set.

6. The method as set forth in claim 5 wherein the training the artificial neural network utilizes a gradient descent feedforward-backpropagation technique.

7. The method as set forth in claim 1 further comprising normalizing each of the plurality of received data points between 0 and 1.

8. An adaptive cruise control apparatus for controlling a speed of a vehicle, comprising:
a distance sensor configured to determine a distance between a controlled vehicle a target vehicle;
an input sensor for sensing an input from a driver of the controlled vehicle in relation to the desired distance between the controlled vehicle and the target vehicle;
an adaptive cruise control module configured to receive a data set of a plurality of data points regarding the operation of the controlled vehicle;
said adaptive cruise control module including an artificial neural network configured to:
receive the data set in response to the input from the driver being sensed, and
calculate a change in the desired distance in response to a change in at least one of the data points; and
wherein said adaptive cruise control module is further configured to change the requested distance based on at least one of the input from the driver and the calculated change in the desired distance by said artificial neural network.
